(19) United States
(12) Patent Application Publication
(10) Pub. No.: US 2008/0162695 A1
(43) Pub. Date: Jul. 3, 2008

(54) Method, Communications Assembly and Communications Device for Controlling the Access to at Least One Communications Device

(75) Inventors: Harald Muhn, Hausham (DE); Thomas Scheller, Munchen (DE); Thomas Vetter, Gablingen (DE)

Correspondence Address: BELL, BOYD & LLOYD, LLP, P.O. BOX 1135, CHICAGO, IL, 60690, US

(73) Assignee: Nokia Siemens Networks GmbH & Co. KG, Muenchen (DE)

(21) Appl. No.: 11/910,193

(22) PCT Filed: Mar. 15, 2006
(86) PCT No.: PCT/EP2006/060750

§ 371 Date: Nov. 20, 2007

(30) Foreign Application Priority Data
Mar. 31, 2005 (DE) 10 2005 014 775.5

(51) Int. Cl. G06F 15/173

(52) U.S. Cl. 709/225

(57) ABSTRACT

The invention relates to a method for controlling the access to at least one communications device (NE) by means of at least one additional communications device (NMS1, NMS2) in a communications network. According to said method, when the aforementioned communications device or devices (NE) is or are accessed, information representing the additional communications device or devices (NMS1, NMS2), such as e.g. the IP address, is recorded. Additional access is then controlled using said information. The invention is characterised in that only certain, predefinable communications devices (NMS1, NMS2) with access can access part of the information stored in the communications device(s) (NE) during a specific time period.

### CLAIM FOR PRIORITY

The application is a national stage application under 35 USC 371 of PCT/EP2006/060750, filed on Mar. 15, 2006, which claims the benefit of priority to DE 10 2005 014 775.5, filed Mar. 31, 2005, the contents of which are hereby incorporated by reference.

### TECHNICAL FIELD OF THE INVENTION

The invention related to a method and device for controlling the access to at least one communications device by at least one additional communications device.

### BACKGROUND OF THE INVENTION

Today's communications networks mostly consist of a number of communications devices. These communications devices or network devices are often divided into network management devices (or network management-stations NMS) and simple network elements (NE). In such case the network management devices can access the individual network devices for reading and mostly also for writing, in order for example to either read out their status or also to configure the network elements in a specific way.

The network management devices and the network elements communicate in such cases by means of suitable protocols. Thus in the LAN (“Local Area Network”) and also in the WAN (“Wide Area Network”) area what is known as the SNMPv1 (“Simple Network Management Protocol Version 1”) protocol is mostly used for access.

The SNMP protocol allows a central network management for a plurality of network elements or network components. The primary objectives of the SNMP are the reduction of the complexity of the management functions, the expandability of the protocol and the independence of specific network components. In such cases the SNMP protocol supports the monitoring, control and the administration of networks.

According to the SNMP architecture model a communication network such as that mentioned above is subdivided into network management devices and network elements. The network management devices in such cases execute applications for monitoring and control of the network elements. The SNMP communication is based on the same management data being administered in a network element and an associated network management device. This data is defined in a configuration table known as the “Management Information Base” (MIB), and exchanged between the network management devices and the network elements with the aid of the SNMP.

On the one hand data can exist in such a configuration table which can only be read out by a configuration management device, on the other hand data can also exist which can be read out and also modified by the network management devices.

These types of changes in the configuration tables, i.e. write accesses to an MIB, mostly mean a change to the configuration or the settings of one or more network devices. In such cases a new configuration process for example can also consist of a series of individual consecutive write accesses. In many data transmission networks it must also be guaranteed that a number of network management devices can have read access and write access to a specific network element.

There is therefore the danger that with such a version of the communications network a number of network management devices will be accessing an individual network element almost at the same time. For example it can occur that a second network management device overwrites the newly written configuration data of a first network management device while the configuration process of the first network management device is not yet completed. Under some circumstances this leads to a misconfiguration of the network element.

### SUMMARY OF THE INVENTION

The invention discloses access to communications devices occurring within the framework of network management especially for arrangements of a number of network management devices in a communication network. In one embodiment of the invention, there is control of access by at least one communications device to at least one further communications device in a communications network. In this case, information representing the at least one further communications device is recorded for an access to the at least one communications device. Further accesses are inventively controlled by information representing the at least one further communications device.

An advantage of the invention is demonstrated by the avoidance of quasi simultaneous access to the same at least one communications device, preventing misconfigurations in the at least one communications device, for example.

Furthermore the control can be arranged so that access to the at least one communications device is undertaken for a predeterminable period of time exclusively by the at least one further communications device represented by the recorded information. This ensures that an access process consisting of a number of individual accesses can also be executed without any problems.

Advantageously, the access to the at least one communications device can be read or write accesses. This especially excludes errors in protocol-based configuration processes.

In addition, access to the at least one communications device can only be to a predeterminable part of information stored in the at least one communications device. This part of the information can also be predetermined for an individual communications device. A part of the stored information in this case is typically to be understood as data or memory sections in the at least one communications device. This information can thus advantageously for example be protected against illegal access.

Another advantage of the invention lies in the fact that the access to the at least one communications device is undertaken exclusively from at least one further predeterminable communications device. This at least one further predeterminable communications device is inventively defined by the information representing this one further predeterminable communications device. Advantageously, access can in this manner for example only be permitted to identified communications devices.

### BRIEF DESCRIPTION OF THE DRAWINGS

The invention is explained in greater detail below with reference to a drawing.

FIG. 1 shows a block diagram of an applications scenario arranged in a communications network in accordance with the invention.

### DETAILED DESCRIPTION OF THE INVENTION

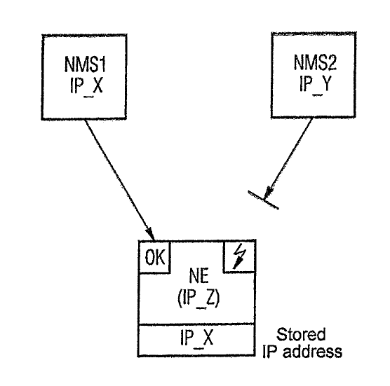

FIG. 1 shows a block diagram of an applications scenario arranged in a communications network (not shown) for executing the inventive method, in which two network management devices NMS1 and NMS2 are assigned to a network element NE arranged in a communication network embodied for example in accordance with the Internet Protocol. Each of these units is assigned an address unique in the communications network, on the basis of which the respective unit is to be uniquely identified.

These addresses can for example be IP addresses.

Within the framework of network management actions a first network management device NMS1 attempts to access the network element NE. In this exemplary embodiment a configuration change is to be undertaken by the network management device NMS1 for network element NE for example.

During the attempted access by network management device NMS1 network management device NMS1 forwards information representing this network management device NMS1 to the network element NE. This information is stored in network element NE and the access attempt is answered by a confirmation by network element NE. The actual write process is started once this has taken place.

Since configuration changes however often consist of a sequence of a number of consecutive write accesses, it is now inventively ensured that the entire sequence of write accesses can run without erroneous interruptions.

To this end, information representing the network management device NMS1 is stored in the network element NE when it is first accessed by the network management device NMS1, as explained above. In this case typically its IP address (here: IP_X). Simultaneously a timer is started in the network element NE by which an indication signal is output after a predeterminable period of time.

Inventively the network element NE is designed so that the network management device for which the IP address has been stored in network element NE (here: IP_X of NMS1) may access the network element NE during the period measured by the timer. After the timer has timed out do all network management devices (NMS1, NMS2) again have unrestricted access to network element NE, i.e. the IP address IP_X stored in network element NE is deleted again.

If before the timer times out a further attempt is made to access network element NE, the transferred IP address (such as IP_Y) is checked in network element NE as detailed above. If this matches the stored IP address (IP_X) can the access be executed.

If for example before the timer times out an access to the network element NE is to be undertaken by a further network management device NMS2, an access attempt by a second network management device NMS2 is thus to be started at a point in time at which accesses to the network element NE are already reserved exclusively for the first network management device NMS1, then this access attempt is negatively assessed by network element NE and rejected.

The period of time during which access to the network element NE by an individual network management device (NMS1, NMS2) remains exclusively reserved can be freely specified in accordance with an advantageous further development of the inventive method. A sensible value here is a time which is tailored to a sequence of contiguous write accesses. Accordingly the period of time should be longer than the duration of an individual access plus the time which elapses between two consecutive accesses within this sequence of contiguous write accesses.

A predetermined period of time of this nature guarantees that any network management device (NMS1, NMS2) can also execute a sequence of a number of contiguous accesses without interruption. According to the inventive method a network element NE remains blocked for other network management devices (NMS2) until a first network management device (NMS1) has completed an access (which can also consist of a number of contiguous individual accesses).

The length of the period of time of the timer as well as further settings can be determined directly via the communication network. Thus values needed can for example be written directly by means of the SNMP protocol into the management information base (MIB) described above of network elements.

Further options are also conceivable for managing or protecting the data or configuration settings stored in the network elements.

By interrogating the IP address of the accessing network management devices (or other information representing the accessing network management device) it can be defined by means of the inventive method for example that specific network management devices only possess precisely defined rights for individual network elements. In other words, it can for example be defined in the configuration tables of the individual network elements that a network management device NMS1 with the IP address IP_X may only have access to a quite specifically predeterminable part of the stored information or data, e.g. exclusively read access.

Such an execution of the inventive method increases the security within the respective communication network. For communication by means of the SNMP protocol only a minimal protection against unauthorized access exists: Here the origin of an SNMP packet is exclusively checked with reference to a so-called community string. A community-string in this case is a character sequence which was agreed beforehand between the network management device and the network element. Only if this specific character sequence appears in the header of the SNMP data packet will the packet be accepted by the corresponding network element.

If this community-string is now known for example there can there be access from any given network management device to the respective network element. Since inventively however the IP address of the accessing device is interrogated, an additional level of security can be implemented with the inventive method: It can thus be defined for example that exclusively network management devices with a specific IP address may access the network element. Furthermore for example those IP addresses which originate from such network management devices which may wish to have unauthorized access to the network element may also be logged and stored in the network element.

1. A method for controlling access to at least one communications device by at least one further communications device in a communication network, comprising:
detecting information representing the at least one further communications device on access to the at least one communications device;
controlling further access to the at least one communications device by the information representing the at least one further communications device such that the at least one communications device is accessed for a determined period by the at least one further communications device represented by the recorded information.

2. The method as claimed in claim 1,
wherein
the access to the at least one communications device is write access or read access.

3. The method according to claim 1,
wherein
the access to the at least one communications device is to a predetermined part of the information stored in the at least one communications device.

4. The method as claimed in claim 1, wherein
the at least one communications device is accessed by the at least one further predetermined communications device.

5. The method as claimed in claim 4,
wherein
the at least one further predetermined communications device is defined by information representing the at least one further predetermined communications device.

6. The method as claimed in claim 1, wherein
the communication network is embodied in accordance with the Internet Protocol.

7. The method as claimed in claim 1, wherein
the information representing the at least one further communications device is embodied as an IP address.

8. The method as claimed in claim 1, wherein
the information representing the at least one further predetermined communications device is embodied as an IP address.

9. The method as claimed in claim 1, wherein
the access is undertaken within the framework of the Simple Network Management Protocol SNMP.

10. A communications assembly, comprising:
at least one communications device arranged in a communications network; and
at least one further communications device arranged in the communications network and accessing the at least one communications device, with the at least one communications device (NE) including
a recording device for recording the information representing the at least one further communications device, and
a controlling device for controlling the further access to the at least one communications device by the recorded information representing the at least one further communications device, wherein the controlling device for controlling the further access are embodied so that the at least one communications device is accessed for a predetermined period of time by the at least one further communications device represented by the recorded information.

11. The communications device for a communications arrangement as claimed in claim 10, further comprising:
a recording device for recording information which represents at least one further communications device accessing the communications device, and
another controlling device for controlling the further access to the communications device by the recorded information representing the at least one further communications device, and the another controlling device for controlling the further access are embodied so that the at least one communications device is accessed for a predetermined period of time by the at least one further communications devices represented by the recorded information.
